(19) United States
(12) Patent Application Publication
(10) Pub. No.: US 2011/0183130 A1
(43) Pub. Date: Jul. 28, 2011

(54) FERRITE-PROVIDED BODY AND FABRICATION METHOD THEREOF

(75) Inventors: Koichi Kondo, Miyagi (JP); Hiroshi Ono, Miyagi (JP); Yukihiro Numata, Miyagi (JP)

(73) Assignee: NEC Tokin Corporation, Sendai-shi, Miyagi (JP)

(21) Appl. No.: 13/121,108

(22) PCT Filed: Jul. 29, 2009
(86) PCT No.: PCT/JP2009/003584

§ 371 Date: Mar. 25, 2011

(30) Foreign Application Priority Data
Sep. 25, 2008 (JP) 2008-245066

(51) Int. Cl. B05D 1/02; B06B 1/00; B05D 3/12; B32B 7/02

(52) U.S. Cl. 428/213; 427/600; 427/209; 427/240; 427/426; 428/332

(57) ABSTRACT

This provides a fabrication method for fabricating a ferrite-provided body comprising a base member 3 and a ferrite film provided on the base member 3. The fabrication method includes: supporting the base member 3 with a space kept on a back of the base member 3, the space being 100 μm or more; supplying a reaction solution and an oxidizing solution for a front of the base member 3 from a reaction solution nozzle 1 and an oxidizing solution nozzle 2, the reaction solution containing at least ferrous ions (Fe²⁺ ions), the oxidizing solution containing at least an oxidizing agent; and applying, to the reaction solution and the oxidizing solution, acceleration of 2˜150 m/s² which comes from a cause other than gravity.

### TECHNICAL FIELD

This invention relates to a ferrite-provided body and a fabrication method thereof, wherein the ferrite-provided body is formed of a base member provided with a ferrite film, especially, a spinel-structured ferrite film.

### BACKGROUND ART

A ferrite plating method provides a fine quality ferrite film and is, for example, disclosed in Patent Document 1. The ferrite plating method of Patent Document 1 comprises the steps of: preparing a specific solution containing at least ferrous ions (Fe²⁺ ions); bringing a surface of a base member into contact with the specific solution to cause Fe²⁺ ions, or Fe²⁺ ions and other metal hydroxide ions, to be absorbed on the surface of the base member; oxidizing the absorbed Fe²⁺ ions to obtain Fe³⁺ ions to cause the Fe³⁺ ions and metal hydroxide ions in the specific solution to undergo a ferrite crystallization reaction so that a ferrite film is formed on the surface of the base member.

The above-described ferrite plating method allows use of any kinds of base members, provided that the base members have tolerance to the solution. The ferrite plating method can produce a spinel-structured ferrite film under a relatively low temperature (the normal temperature to the boiling point of the solution or lower) because it is based on the reaction by using the solution. The ferrite plating method is superior to other ferrite film formation techniques in less limitations for the base member.

There are provided Patent Document 2 to Patent Document 4 as documents concerning the ferrite plating method. Patent Document 2 discloses a technique which homogenizes ferrite films formed and increases reaction rate in a ferrite film formation process. Patent Document 3 discloses a technique which makes a surface of a base member active so that ferrite films can be formed on various base members. Patent Document 4 discloses a technique which relates to increase of ferrite film formation rate.
Patent Document 1: JPB1475891 (JPB S63-15990)
Patent Document 2: JPB1868730 (JPB H05-58252)
Patent Document 3: JPA S61-030674
Patent Document 4: JPA H02-166311

### DISCLOSURE OF INVENTION

### Problems to be Solved by Invention

According to the above-described ferrite plating method, a ferrite film is formed by crystal growth which is carried out from a base member's surface as a starting point. Therefore, a suitably-formed ferrite film becomes a collection of columnar crystals each of whose long axis extends along a direction substantially parallel with a direction of the normal to the base member's surface.

However, if the remnant solutions or the like are not completely removed from the base member upon formation of a ferrite film, stagnant solution appears thereon. The appearance of the stagnant solution makes it difficult to obtain a ferrite film formed of a collection of homogeneous columnar crystals. Especially in case of a base member with a three-dimensional shape such as a lead frame for semiconductor device, stagnant solution easily appears so that it is difficult to obtain a homogeneous ferrite film.

It is therefore an object of the present invention to provide a fabrication method of a ferrite-provided body which has a homogeneous ferrite film, wherein the fabrication method is based on the ferrite plating method.

In addition, it is another object of the present invention to provide a ferrite-provided body which is fabricated in accordance with the above-mentioned fabrication method thereof.

### Means for Solving the Problems

One aspect of the present invention provides a fabrication method for fabricating a ferrite-provided body comprising a base member and a ferrite film provided on the base member. The fabrication method includes: supporting the base member with a space kept on a back of the base member, the space being 100 μm or more; supplying a reaction solution and an oxidizing solution for a front of the base member, the reaction solution containing at least ferrous ions (Fe²⁺ ions), the oxidizing solution containing at least an oxidizing agent; and applying, to the reaction solution and the oxidizing solution, acceleration of 2˜150 m/s² which comes from a cause other than gravity.

Another aspect of the present invention provides a ferrite-provided body comprising a base member having a three-dimensional shape and a ferrite film provided on the base member, wherein a ratio σ/x of an average film thickness x of the ferrite film to a standard deviation σ of thicknesses of the ferrite film is 1 or less.

### Advantageous Effect of Invention

Columnar crystals of the ferrite film are made grow under conditions where the base member is disposed by 100 μm or more away from the support table and so on while acceleration of 2˜150 m/s² is applied to the reaction solution and the oxidizing solution, wherein the acceleration comes from a cause other than gravity. Therefore, appearance of stagnant solution can be prevented while a homogeneous ferrite film can be obtained.

### BRIEF DESCRIPTION OF DRAWINGS

FIG. 1 is a view schematically showing a film formation apparatus which is used in a fabrication method of a ferrite-provided body according to an embodiment of the present invention.

FIG. 2 is a view schematically showing a base member of a ferrite provided body according to an embodiment of the present invention.

FIG. 3 is a view schematically showing a fabrication method of a ferrite-provided body according to its application.

### DESCRIPTION OF NUMERALS

1 Reaction Solution Nozzle
2 Oxidizing Solution Nozzle
3 Base Member
4 Support Member
5 Support Table (Turn Table)
6 Ferrite Film

### BEST MODE FOR CARRYING OUT INVENTION

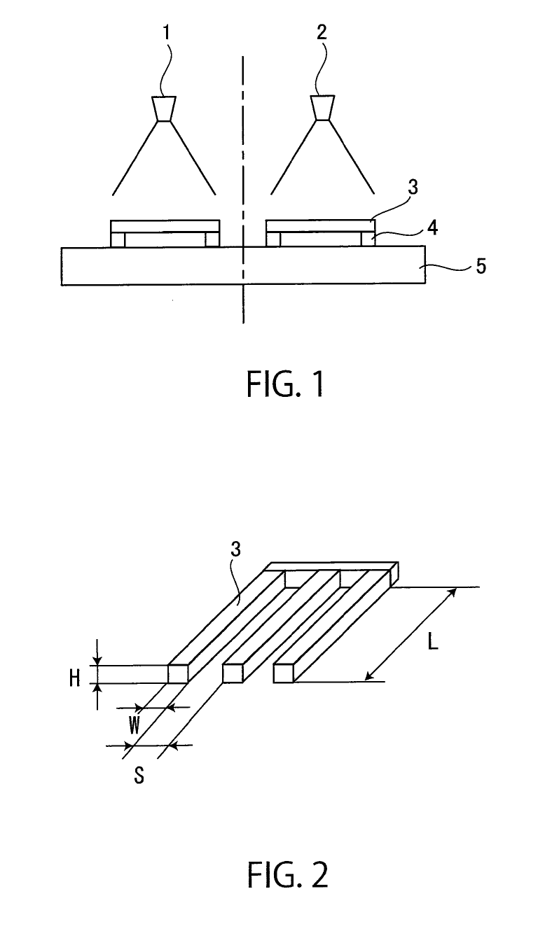

A fabrication method of a provided body, which includes a base member and a ferrite film provided on the base member, according to an embodiment of the present invention uses a film formation apparatus as shown in FIG. 1.

The illustrated film formation apparatus is an apparatus for forming a ferrite film on a base member 3 and comprises a reaction solution nozzle 1, an oxidizing solution nozzle 2, a support member 4 and a support table (turn table) 5. The turn table 5 is a table turnable around its axis. The support member 4 is placed on the turn table 5 and is configured to support the base member 3 with a space of 100 μm or more left between the back of the base member 3 and the turn table 5. The support member 4 moves in response to the turning of the turn table 5, while supporting the base member 3. In other words, the base member 3 moves in response to the turning of the turn table 5. The reaction solution nozzle 1 is configured to supply a reaction solution for the turn table 5, wherein the reaction solution contains at least ferrous ions (Fe²⁺ ions). The reaction solution nozzle 1 is fixed above the turn table 5. The oxidizing solution nozzle 2 is configured to supply an oxidizing solution for the turn table 5, wherein the oxidizing solution contains at least an oxidizing agent. The oxidizing solution nozzle 2 is fixed above the turn table 5. In the illustrated film formation apparatus, the reaction solution nozzle 1 is positioned above one of half regions of the turn table 5 stopped, while the oxidizing solution nozzle 2 is positioned above the other half region of the turn table 5 stopped. In the illustrated film formation apparatus, each of the reaction solution nozzle 1 and the oxidizing solution nozzle 2 is configured to spray it for the turn table 5 while its center is a direction perpendicular to the turn table 5. In other words, the center lines of the spray directions of the reaction solution and the oxidizing solution sprayed from the reaction solution nozzle 1 and the oxidizing solution nozzle 2 are parallel to the direction perpendicular to the surface of the base member 3. However, the present invention is not limited thereto. The base member 3 and/or the reaction solution nozzle 1 and the oxidizing solution nozzle 2 may be inclined to each other to spray the reaction solution and the oxidizing solution in directions obliquely to the surface of the base member 3.

When the support member 4 supports the base member 3 while the turn table 5 is turned with the reaction solution and the oxidizing solution respectively supplied from the reaction solution nozzle 1 and the oxidizing solution nozzle 2, the reaction solution and the oxidizing solution are alternately supplied for the base member 3. As the result, the base member is ferrite plated. Namely, the ferrite film based on the ferrite plating method is formed on the base member 3.

The turning rate of the turn table 5 according to the present embodiment is set so that the reaction solution and the oxidizing solution supplied on the base member 3 are provided with acceleration of 2˜150 m/s² which comes from a centrifugal force thereof. The acceleration causes a remnant reaction solution and a remnant oxidizing solution to move from the front of the base member 3 to its back and so on so that they do not form undesirable “stagnant solution”. Especially, even if the base member 3 has a narrow clearance, the remnant reaction solution and the remnant oxidizing solution move smoothly without forming undesirable “stagnant solution” in the present embodiment. As described above, the ferrite plating method can be embodied under ideal conditions in the present embodiment. Therefore, a homogeneous ferrite film can be obtained. In addition, the remnant reaction solution and the remnant oxidizing solution move to the back of the base member 3 so that a ferrite film can be also formed on a portion other than the front of the base member where the reaction solution and the oxidizing solution are supplied directly.

In the above-described embodiment, the acceleration applied to the reaction solution and the oxidizing solution is one caused by the centrifugal force produced by turning the turn table 5. However, the present invention is not limited thereto. The acceleration applied to the reaction solution and the oxidizing solution may be any acceleration, provided that it is intentional acceleration (i.e., acceleration other than the gravity) and falls in a range of 2˜150 m/s². For example, another measure to apply acceleration is to apply vibration to the base member 3.

In the present embodiment, the supply of the reaction solution and the oxidizing solution and the applying of the acceleration are carried out at roughly the same time. However, the present invention is not limited thereto. Provided that the remnant reaction solution and the remnant oxidizing solution can be removed, the acceleration may be applied just after the supply of the reaction solution and the oxidizing solution, as well as a cycle of the supply of the reaction solution, the applying of the acceleration, the supply of the oxidizing solution and the applying of the acceleration may be repeatedly carried out.

In order to make more smooth flow of the remnant reaction solution and the remnant oxidizing solution and to make it sure to prevent the formation of the stagnant solution, it is preferable that the shape and the size of the base member 3 are limited as follows. For example, if the base member 3 has a stick-shaped portion as a single conductor, it is preferable that the stick-shaped portion has the maximum width of 5 mm or less and the maximum height of 5 mm or less. If the base member 3 has a plurality of stick-shaped portions with clearances left between as a comb-like wiring pattern illustrated in FIG. 2, it is preferable that each of the stick-shaped portions has the maximum width (W) of 5 mm or less and the maximum height (H) of 5 mm or less and that each of the clearances (S) is 100 μm or more.

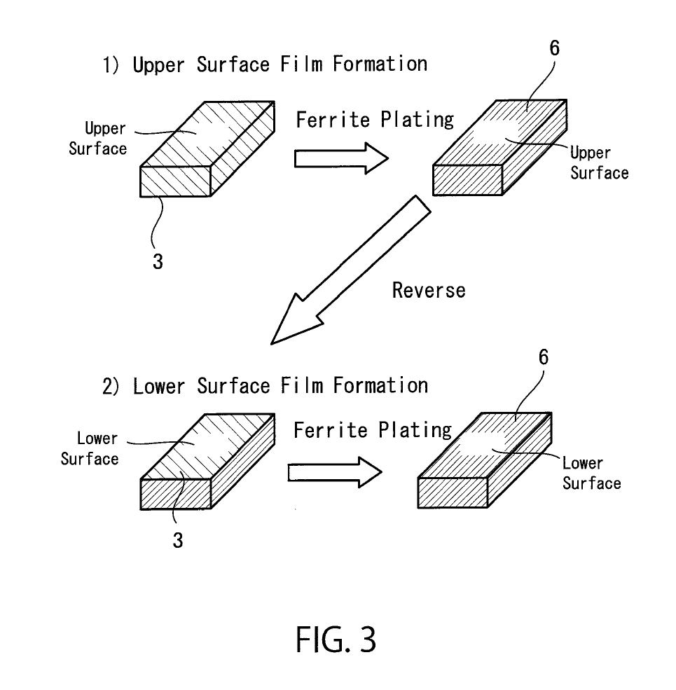

Furthermore, after the ferrite film is directly formed on the front of the base member 3 as described above, the base member 3 may be reversed, and then, a ferrite film may be directly formed on the back of the base member 3 in the same manner. For example, the following processes may be carried out as shown in FIG. 3: a homogeneous ferrite film (ferrite plated film) 6 is formed on the upper surface of the base member 3 by supplying the reaction solution and the oxidizing solution therefor and simultaneously by applying the acceleration thereto; the base member 3 is then reversed; and another homogeneous ferrite film (ferrite plated film) is formed on the lower surface of the base member 3 by supplying the reaction solution and the oxidizing solution therefor and simultaneously by applying the acceleration thereto.

The ferrite film (ferrite plated film) formed in accordance with the present embodiment is formed of an ideal arrangement of a plurality of columnar crystals each of which has a long axis and a short axis. In detail, the plurality of columnar crystals are arranged so that their long axes extend along a direction of the normal to a surface of the base member 3 (i.e., a thickness direction of the ferrite film), while the columnar crystals are magnetically coupled with each other. Especially, ferrite films formed on adjacent two surfaces such as an upper surface and a side surface are magnetically coupled with each other. The long axis (a) of the columnar crystal is 0.1˜10 μm, while the short axis (b) thereof is 0.1˜1 μm. In addition, a ratio (σ/x) of an average film thickness (x) of the ferrite film to a standard deviation (a) of thicknesses of the ferrite film is 1 or less.

For property evaluation of ferrite-provided body, ferrite-provided bodies were formed under various conditions shown in the following table. In the table, each of concrete examples 1˜4 is a ferrite-provided body fabricated under a condition according to the present embodiment, while each of comparative examples 1˜5 is a ferrite-provided body fabricated under a condition which is not the condition according to the present embodiment.

TABLE 1-1

| | | | Distance from | | |
|---|---|---|---|---|---|
| | | | Turn Center to | Movement | Acceleration |
| | Number | Turning | Position of Base | Rate of Base | of Base |
| | of Film | Rate | Member Disposed | Member | Member |
| | Formation | (rpm) | r (m) | v (m/s) | v²/r (m/s²) |
| Concrete | 1 | 60 | 0.05 | 0.3 | 2.0 |
| Example 1 | | | | | |
| Concrete | 1 | 240 | 0.05 | 1.3 | 31.6 |
| Example 2 | | | | | |
| Concrete | 1 | 300 | 0.15 | 4.7 | 147.9 |
| Example 3 | | | | | |
| Concrete | 2 | 300 | 0.15 | 4.7 | 147.9 |
| Example 4 | | | | | |
| Comparative | 1 | 60 | 0.05 | 0.3 | 2.0 |
| Example 1 | | | | | |
| Comparative | 1 | 120 | 0.05 | 0.6 | 7.9 |
| Example 2 | | | | | |
| Comparative | 1 | 120 | 0.05 | 0.6 | 7.9 |
| Example 3 | | | | | |
| Comparative | 1 | 30 | 0.15 | 0.5 | 1.5 |
| Example 4 | | | | | Smaller than |
| | | | | | Lower Limit |
| Comparative | 1 | 350 | 0.15 | 5.5 | 201.3 |
| Example 5 | | | | | Larger than |
| | | | | | Upper Limit |

TABLE 1-2

| | Line Width | Line height | Line Clearance | Space Between |
|---|---|---|---|---|
| | of Base | of Base | of Base | Base Member |
| | Member | Member | Member | and Turn Table |
| | w (mm) | H (mm) | S (mm) | (mm) |
| Concrete | 5 | 5 | 0.2 | 1 |
| Example 1 | | | | |
| Concrete | 0.2 | 0.2 | 0.2 | 0.3 |
| Example 2 | | | | |
| Concrete | 0.2 | 0.2 | 0.1 | 0.1 |
| Example 3 | | | | |
| Concrete | 0.2 | 0.2 | 0.2 | 0 |
| Example 4 | | | | |
| Comparative | 5 | 5 | 0.2 | 0.05 |
| Example 1 | | | | Smaller than |
| | | | | Lower Limit |
| Comparative | 5.5 | 5.5 | 0.2 | 1 |
| Example 2 | Larger than | Larger than | | |
| | Upper Limit | Upper Limit | | |
| Comparative | 4 | 4 | 0.05 | 1 |
| Example 3 | | | Smaller than | |
| | | | Lower Limit | |
| Comparative | 5 | 5 | 0.2 | 1 |
| Example 4 | | | | |
| Comparative | 5 | 5 | 0.2 | 1 |
| Example 5 | | | | |

TABLE 1-3

| | | | Long Axis | Short | | | Standard | |
|---|---|---|---|---|---|---|---|---|
| | | | of | Axis of | | Average | Deviation | |
| | | | Columnar | Columnar | | Film | of Film | |
| | | μ′ | Crystal | Crystal | Film | Thickness | Thickness | |
| | | (at | a | b | Thickness | x | σ | |
| | Position | 1 MHz) | (μm) | (μm) | (μm) | (μm) | (μm) | σ/x |
| Concrete | Front | 35 | 3.2 | 0.2 | 3.2 | 2.3 | 0.6 | 0.25 |
| Example 1 | Back | | 2.1 | 0.3 | 2.1 | | | |
| | Side (1) | | 2.1 | 0.2 | 2.1 | | | |
| | Side (2) | | 2.1 | 0.2 | 2.1 | | | |
| Concrete | Front | 36 | 3.2 | 0.2 | 3.2 | 3.1 | 0.1 | 0.03 |
| Example 2 | Back | | 3.2 | 0.2 | 3.2 | | | |
| | Side (1) | | 3.2 | 0.2 | 3.2 | | | |
| | Side (2) | | 3.1 | 0.2 | 3.1 | | | |
| Concrete | Front | 12 | 2.9 | 0.08 | 2.9 | 2.7 | 0.4 | 0.15 |
| Example 3 | Back | | 2.1 | 0.2 | 2.1 | | | |
| | Side (1) | | 3 | 0.1 | 3 | | | |
| | Side (2) | | 2.9 | 0.2 | 2.9 | | | |
| Concrete | Front | 19 | 2.9 | 0.08 | 2.9 | 2.7 | 0.4 | 0.15 |
| Example 4 | Back | | 2.1 | 0.2 | 2.1 | | | |
| | Side (1) | | 3 | 0.1 | 3 | | | |
| | Side (2) | | 2.9 | 0.2 | 2.9 | | | |
| Comparative | Front | 8 | 3.8 | N/M | 3.8 | 1.5 | 1.6 | 1.05 > 1 |
| Example 1 | Back | Smaller | 0.09 | | 0.09 | | | |
| | Side (1) | than | 1.3 | | 1.3 | | | |
| | Side (2) | Average | 0.9 | | 0.9 | | | |
| Comparative | Front | 9 | 3.2 | 0.2 | 3.2 | 1.3 | 1.4 | 1.01 > 1 |
| Example 2 | Back | Smaller | N/M | N/M | 0.06 | | | |
| | Side (1) | than | 1.3 | 0.2 | 1.3 | | | |
| | Side (2) | Average | 0.7 | 0.2 | 0.7 | | | |
| Comparative | Front | 9 | 3.8 | 0.1 | 3.8 | 1.6 | 1.6 | 1.01 > 1 |
| Example 3 | Back | Smaller | 0.1 | 0.2 | 0.1 | | | |
| | Side (1) | than | 1.5 | 0.2 | 1.5 | | | |
| | Side (2) | Average | 0.9 | 0.3 | 0.9 | | | |
| Comparative | Front | 9 | 3.2 | 0.3 | 3.2 | 1.3 | 1.3 | 1.06 > 1 |
| Example 4 | Back | Smaller | N/M | N/M | 0.08 | | | |
| | Side (1) | than | 1 | 0.4 | 1 | | | |
| | Side (2) | Average | 0.8 | 0.4 | 0.8 | | | |
| Comparative | Front | 8 | 2.9 | 0.08 | 2.9 | 1.2 | 1.2 | 1.03 > 1 |
| Example 5 | Back | Smaller | N/M | N/M | 0.1 | | | |
| | Side (1) | than | 1 | 0.2 | 1 | | | |
| | Side (2) | Average | 0.7 | 0.2 | 0.7 | | | |

*N/M: not measurable

For fabrication of the ferrite-provided bodies, the above-described film formation apparatus illustrated in FIG. 1 was used. The base member 3 was made of copper alloy and had a structure as shown in FIG. 3, wherein length (L) of the stick-shaped portion of the base member 3 was 30 mm. For each of the concrete examples 1˜4 and the comparative examples 1˜5, the height (H) and the width (W) of the stick-shaped portion of the base member 3 as well as the clearance (S) of the stick-shaped portions (distance between the lines) of the base member 3 are those as shown in the table.

As a pre-treatment, the turn table 5 was turned after the base member 3 was disposed on the support member 4, while deoxidized ion-exchange water was provided on the base member 3 under a heat treatment up to 90° C. Next, nitrogen gas was introduced into the film formation apparatus so that deoxide atmosphere was prepared in the apparatus.

Then, the step of supplying the reaction solution for the base member 3 from the reaction solution nozzle 1 and the step of supplying the oxidizing solution for the base member 3 from the oxidizing solution nozzle 2 were carried out while the turn table 5 was turned. In other words, the step of supplying the reaction solution and the step of supplying the oxidizing solution were carried out alternately and repeatedly. Flow rate upon the supply of each of the reaction solution and the oxidizing solution was set to 40 ml/min. The reaction solution was prepared by dissolving FeCl₂-4H₂O, NiCl₂-6H₂O, ZnCl₂ into deoxidized ion-exchange water. The oxidizing solution was prepared by dissolving NaNO₂ and CH₃COONH₄ into deoxidized ion-exchange water. The reaction solution and the oxidizing solution may be formed with reference to, for example, US2009-0047507A1, US2007-0231614A1, or other materials.

Upon the supplying of the reaction solution and the oxidizing solution for the base member 3, the turn table 5 was turned at turning rates shown in the table to apply, to the reaction solution and the oxidizing solution, accelerations shown in the same table. As for the concrete example 2, a ferrite film 6 was formed on the upper surface of the base member 3, and then the base member 3 was reversed so that a ferrite film 6 was formed on the lower surface of the base member 3, too, as shown in FIG. 3. During that, a space of 200 μm was left between the base member 3 and the turn table 5.

As a result of the above-explained processes, black ferrite films were formed on the base members 3, respectively. Various analyses were carried out on the thus formed ferrite-provided bodies. In detail, chemical composition of each ferrite film was examined by an inductively coupled plasma spectroscopy (ICPS) method. A scanning electron microscope (SEM) was used for a configuration analysis such as measurement of film thickness. Permeability of each ferrite film was measured by the use of a permeability measurer based on a shielded loop coil method. As a result of the examination by the ICPS method, each of the ferrite films of the ferrite-provided bodies has an average composition of Ni_{0.2}Zn_{0.3}Fe_{2.5}O₄. The other results of analyses are shown in the foregoing table.

As apparent from the contents of the table, each of the ferrite films of the ferrite-provided bodies of the concrete examples 1˜4 is formed of a plurality of columnar crystals magnetically coupled with each other, wherein each of the columnar crystals has a long axis and a short axis. The long axis of each columnar crystal extends along the thickness direction of the ferrite film (i.e., a direction of the normal to a surface of the base member 3). The length of the long axis of the columnar crystal falls in a range of 0.1˜10 μm, while the length of the short axis thereof falls in a range of 0.1˜1 μm. In addition, a ratio (σ/x) of an average film thickness (x) of the ferrite film to a standard deviation (σ) of thicknesses of the ferrite film is 1 or less. Because of those, the real part μ′ of the permeability of the ferrite film has an average value of 10 or more. On the other hand, as for the ferrite-provided bodies of the comparative examples 1˜5, an average value of the real part μ′ of the permeability of the ferrite film is less than 10. As described above, the present embodiment can provide a ferrite-provided body which includes a ferrite film having superior magnetic properties.

### INDUSTRIAL APPLICABILITY

A ferrite-provided body according to the present invention can be used in an inductance element, an impedance element, a magnetic head, a microwave element, a magnetostriction element and a high-frequency magnetic device such as an electromagnetic interference suppressor. The electromagnetic interference suppressor is for suppressing electromagnetic problems caused by interferences of undesired electromagnetic waves in a high frequency region.

1. A fabrication method for fabricating a ferrite-provided body comprising a base member and a ferrite film provided on the base member, the fabrication method comprising:
supporting the base member with a space kept on a back of the base member, the space being at least 100 μm;
supplying a reaction solution and an oxidizing solution for a front of the base member, the reaction solution containing at least ferrous ions (Fe²⁺ ions), the oxidizing solution containing at least an oxidizing agent; and
applying, to the reaction solution and the oxidizing solution, acceleration of 2˜150 m/s² which comes from a cause other than the gravity.

2. The fabrication method as recited in claim 1, wherein the support of the base member is performed by disposing a support member on a support table and by supporting the base member by the support member with the space kept between the support table and the base member.

3. The fabrication method as recited in claim 2, wherein the acceleration is caused by a centrifugal force produced by turning the support table.

4. The fabrication method as recited in claim 1, wherein the acceleration is produced by providing the base member with vibration.

5. The fabrication method as recited in claim 1, wherein the base member has a stick-shaped portion which has a maximum width of not more than 5 mm and a maximum height of not more than 5 mm.

6. The fabrication method as recited in claim 1, wherein the base member has a plurality of stick-shaped portions with clearances left therebetween, each of the stick-shaped portions having a maximum width of not more than 5 mm and a maximum height of not more than 5 mm, and each of the clearances being at least 100 μm.

7. The fabrication method as recited in claim 1, wherein the reaction solution and the oxidizing solution are supplied directly on a front of the base member and the acceleration is applied to form a ferrite film directly on the front of the base member, and then, the reaction solution and the oxidizing solution are supplied directly on the back of the base member and the acceleration is applied to form a ferrite film directly on the back of the base member.

8. A ferrite-provided body comprising a base member having a three-dimensional shape and a ferrite film provided on the base member, wherein a ratio σ/x of an average film thickness x of the ferrite film to a standard deviation σ of thicknesses of the ferrite film is not more than 1.

9. The ferrite-provided body as recited in claim 8, wherein:
the base member has at least two surfaces adjacent to each other;
the ferrite film is formed directly on each of the two surfaces; and
the ferrite films formed on the two surfaces are coupled magnetically with each other.

10. The ferrite-provided body as recited in claim 8, wherein the base member has a stick-shaped portion which has a maximum width of not more than 5 mm and a maximum height of not more than 5 mm.

11. The ferrite-provided body as recited in claim 8, wherein the base member has a plurality of stick-shaped portions with clearances left therebetween, each of the stick-shaped portions having a maximum width of not more than 5 mm and a maximum height of not more than 5 mm, each of the clearances being at least 100 μm.

12. The ferrite-provided body as recited in claim 8, wherein:
the ferrite film comprises a plurality of columnar crystals each of which has a long axis and a short axis, each long axis extending along a thickness direction of the ferrite film; and
the long axis of the columnar crystal is 0.1˜10 μm, and the short axis thereof is 0.1˜1 μm.
